(19) United States
(12) Patent Application Publication
(10) Pub. No.: US 2008/0320105 A1
(43) Pub. Date: Dec. 25, 2008

(54) SYSTEM, SERVER AND INFORMATION TERMINAL FOR DETECTION OF A BLACK HAT

(76) Inventors: Norihiko NAONO, Tokyo (JP); Tomohisa Ota, Tokyo (JP)

Correspondence Address: WINSTON & STRAWN LLP;PATENT DEPARTMENT, 1700 K STREET, N.W., WASHINGTON, DC, 20006, US

(21) Appl. No.: 12/139,024

(22) Filed: Jun. 13, 2008

(30) Foreign Application Priority Data
Jun. 21, 2007 (JP) P2007-163789

(51) Int. Cl. G06F 15/173; G06F 17/30

(52) U.S. Cl. 709/219; 707/3; 707/E17.108

(57) ABSTRACT

A system includes an information terminal of a user B which stores information of users A and B; an information terminal of a user C which stores information of users A and B; and a server. The information terminal of the user B generates a first calculation result by an arbitrary calculation of the information stored therein and sends this result to the server to be registered. The server correlates an identification tag of the user B with the first calculation result and stores this information. The information terminal of user C generates a second calculation result by the arbitrary calculation of information stored therein and sends this result to the server to be registered. The server correlates an identification tag of the user C with the second calculation result and stores this information. The server searches for a calculation result which matches the first calculation result and sends an identification tag which is correlated with the second calculation result or flag information to show that the first and second calculation results match.

### CROSS REFERENCE TO RELATED APPLICATION

This application is based upon and claims the benefit of priority from the prior Japanese Patent Application No. 2007-163789, filed on Jun. 21, 2007; the entire contents of which are incorporated by reference.

### BACKGROUND OF THE INVENTION

1. Field of the Invention

The present invention is related to a server, an information terminal, a communication terminal, a system, an identification method, an application software, and a middleware.

2. Description of the Related Art

In recent years, various information terminals such as a personal computer, a telephone, a game console etc. can be connected to an IP network. The Internet, which has been used to disclose information stored on a server to the world, is now used as means for communication between individuals such as a service to exchange information with the recipients of the disclosed information services such as an IP phone system, network games or social network sites (SNS).

The connection of various consumer products such as a digital camera, a video camera, a portable audio player, a video recorder, a navigation system, etc. with an IP network is progressing and it is expected that in future these consumer products can be used as information terminals for communication between individuals.

In order to communicate or exchange information by using various information terminals connected to a network, the users must search and find the acquaintance on the network with whom they wish to communicate.

In most of the services, since the operations such as communication between individuals or information exchange is executed on the server of a service provider, once the user is authenticated after logging in, to search the acquaintance for communication, the users specify their acquaintances and communicate with them by directly searching the personal information disclosed and registered with the service provider by those acquaintances.

The service architectures such as those of Peer-to-Peer (P2P) systems, which do not depend on central servers, for communication service or information exchange between individuals, while searching an acquaintance for communication, require that a query be sent to an adjacent node in order to search the acquaintance based on the individual information disclosed to the subscribers of the service by a subscriber. When the individual information of the acquaintance, which is the search target of this query, does not exist in this node, the query is forwarded to a different adjacent node. The query is forwarded to other nodes until the node having the desired individual information is found. Once that node is found, the acquaintance for communication is specified and communication is established by obtaining the ID of that acquaintance on the network.

As mentioned above, after the personal information is searched on the server, if matching personal information is found in a database, respective network IDs are notified to the user for communication. A hybrid service is suggested, wherein the users are directly connected by P2P for data transfer, for example in the Japan Patent Laid-open 2006-244095.

### BRIEF SUMMARY OF THE INVENTION

The following are three main problems that occur while searching the personal information on the server or P2P network in order to select a communication partner or to obtain a network ID for communication between individuals or for data exchange. These three problems need to be solved.

The first problem relates to the confidentiality of personal information. Personal information which is registered by the user of these types of services can be inquired as a search target by all the users of this service, and when the inquired information and the information in the database match it is notified to the user inquiring the information. Therefore, personal information registered by various unspecified users can be obtained. If the search targets are to be scanned by using a crawling type software, a list of users of such a service can also be created. The user of this type of service is registered and personal information that is used for searching is disclosed to all the users of this service. Since personal information stored as a database on the server is disclosed to the service provider by the service user, there is a danger of the information being leaked in some format. Disclosure of personal information by a user to the service provider and the service user is inevitable so that anybody can search for the user and therefore secrecy of their personal information expected by the user is contradictory to this condition.

The second problem is that there is no means for a user to prevent unwanted acquaintances from searching for this user. For example, in the phone book of an IP phone, when user names are registered on the server as personal information for searching, anybody in the world knowing this user's name is able to call this user. Similarly, if a real name is registered in an SNS service, personal relations, activities, preferences etc., which a user does not want informed to their place of employment may be leaked. A malicious third-party automatically sends many inquiries related to this search, creates name (full name) or other related information and creates a database such as ID, on the network, and may misuse all this created information. These all are legal activities and technical as well as legal actions can not prevent these activities.

The third problem is that there are no means to prevent the user with malicious intent from pretending to be other user. The personal information of a user sent from an information terminal of a user and the information (hereafter, this information is referred to as contact information) for identifying this user uniquely in this communication service is correlated and this information is stored in a database on the server of the communication provider. The user, who searches for a communication partner, obtains the contact information of the communication partner by searching in this database by considering any personal information of the communication partner as a search key. However, the personal information that is the search key registered in the database on the server of the above-mentioned communication provider is the self-certified information by each user of this communication service and thus spoofing is easy. For example, User C, pretending to be User B, who is the other user, can also register the personal information of user B. In this case, it may happen that another User A, who attempts to search for User B from the above-mentioned database with the intention of obtaining the contact information of User B, may actually obtain the contact information of User C. This is referred to as spoofing and it is one of the typical attacks against authentication. The third user with malicious intent who creates this meet-in-the-middle attack is generally referred to as a black hat. In order to prevent this spoofing, a method where each user's identity is verified while registering the personal information on the server of this communication service, is available. For example, the personal information is registered at a counter and independent confirmation of the user by her/his driving license or passport attached with a photograph is carried out. However, this type of method is rarely adopted as it is expensive and because personal information for searching by self-certification is registered in all communication services, it is difficult to resolve the problem of preventing the spoofing by a third user by the conventional search method.

Due to these three problems, in the services for communicating or exchanging information between individuals, most of the users desire to remove their real name from the personal information registered on the server that can be the target of a search. As a result, a user primarily uses a nickname in the personal information that can be the target of a search by which their identity can not be verified and this leads to communication between anonymous users in this type of service.

For example, however, communication with real names is essential in many IP phones and SNS services. According to conventionally used methods, communication is almost established after acquiring a nickname from an acquaintance to be directly communicated with and searching for it in an IP phone or an SNS service with the help of a communication method using real names in the case of E-mail, conversation etc. However, a search with real names, which is fundamentally necessary in such types of services, does not function.

If a user registers only anonymous information on the server of a service provider as a search key, then the above-mentioned first and second problems can be resolved at the cost of a search function. However, though this method is available, the above-mentioned third problem, in other words, avoiding the spoofing performed by a third user with a malicious intention, was difficult in other methods where an additional cost is required for improving the authentication level.

A system of an embodiment of the present invention comprises: an information terminal of a user B which stores information Pa′ of a user A and information Pb of the user B; an information terminal of a user C which stores information Pa″ of the user A and information Pb″ of the user B; and a server; wherein the information terminal of the user B generates a first calculation result F(Pa′, Pb) by an arbitrary calculation of information Pa′ of the user A and information Pb of the user B and sends the first calculation result F(Pa′, Pb) to the server to be registered in the server, the server correlating an identification tag of the user B with the first calculation result F(Pa′, Pb) and storing the identification tag of the user B and the first calculation result F(Pa′, Pb), and the information terminal of the user C generates a second calculation result F(Pa″, Pb″) by the arbitrary calculation of information Pa″ of the user A and information Pb″ of the user B and sends the second calculation result F(Pa″, Pb″) to the server to be registered in the server, the server correlating an identification tag of the user C with the second calculation result F(Pa″, Pb″) and storing the identification tag of the user C and the second calculation result F(Pa″, Pb″), and the server searches for a calculation result which matches the first calculation result F(Pa′, Pb) and sends an identification tag which is correlated with the second calculation result F(Pa″, Pb″), or flag information, the identification tag or the flag information showing that the first calculation result F(Pa′, Pb) and the second calculation result F(Pa″, Pb″) match.

A server of another embodiment of the present invention comprises a data processor, the data processor receives a first calculation result F(Pa′, Pb) which is calculated by an arbitrary calculation of information Pa′ of a user A and information Pb of a user B, the first calculation result F(Pa′, Pb) being generated in an information terminal of the user B, and correlating an identification tag of the user B with the first calculation result F(Pa′, Pb) and stores the identification tag of the user B and the first calculation result F(Pa′, Pb), and receiving a second calculation result F(Pa″, Pb″) which is calculated by an arbitrary calculation of information Pa″ of the user A and information Pb″ of the user B, the second calculation result F(Pa″, Pb″) being generated in an information terminal of the user C, and correlating an identification tag of the user C with the second calculation result F(Pa″, Pb″) and stores the identification tag of the user C and the second calculation result F(Pa″, Pb″).

An information terminal of another embodiment of the present invention comprises: a calculation unit which generates a first calculation result F(Pa, Pb′) calculated by an arbitrary calculation of information Pa of a user A and information Pb′ of a user B; a sending unit which sends the first calculation result F(Pa, Pb′) to a server, and; a receiving unit, wherein the server searches for a calculation result which matches the first calculation result F(Pa, Pb′) which is sent from an information terminal of the user A, the calculation result being either a second calculation result F(Pa′, Pb) which is calculated by the arbitrary calculation of information Pa′ of the user A and information Pb of the user B, second calculation result F(Pa′, Pb) being correlated with an identification tag of the user B and stored in the server and sent by an information terminal of the user B, or a third calculation result F(Pa″, Pb″) which is calculated by the arbitrary calculation of information Pa″ of the user A and information Pb″ of the user B, third calculation result F(Pa″, Pb″) being correlated with an identification tag of the user C and stored in the server and sent by an information terminal of the user C, and by detecting a match between the first calculation result F(Pa, Pb′) and second calculation result F (Pa′, Pb) or the first calculation result F(Pa, Pb′) and the third calculation result F(Pa″, Pb″) receives an identification tag of the user B or the user C which is correlated with the matching calculation result, the identification tag of the user B or the user C being sent to an information terminal of the user A, or flag information, the flag information and the identification tag of the user B or the user C showing a match between the first calculation result F(Pa, Pb′) and second calculation result F(Pa′, Pb) or the first calculation result F(Pa, Pb′) and the third calculation result F(Pa″, Pb″).

An information terminal of another embodiment of the present invention comprises: a calculation unit which generates a first calculation result F(Pa′, Pb) calculated by an arbitrary calculation of information Pb of a user B and Pa′ of a user A; a sending unit which sends the first calculation result F(Pa′, Pb) to a server, and; a receiving unit, wherein the server detects a match between a second calculation result F(Pa″, Pb″) calculated by an arbitrary calculation of information Pa″ of the user A and Pb″ of the user B, the information being stored in an information terminal of the user C and correlated with an identification tag of the user C and sent by an information terminal of the user C, and the first calculation result F(Pa′, Pb) which is received by the server from an information terminal of the user B, and the receiving unit receives either the identification tag of the user C which is sent to an information terminal of the user B, or flag information, the flag information and the identification tag of the user C showing a match between the first calculation result F(Pa′, Pb) and the second calculation result F(Pa″, Pb″).

A system of another embodiment of the present invention comprises: an information terminal of a user B that stores a part of or all of information P1a′, P2a′, . . . , Pna′ (where n is an integer) of a user A and a part of or all of information P1b, P2b, . . . , Pmb (where m is an integer) of the user B; an information terminal of a user C that stores a part of or all of information P1a″, P2a″, . . . , Pna″ of the user A and a part of or all of information P1b″, P2b″, . . . , Pmb″ of the user B; and a server; wherein the information terminal of the user B generates one or more first calculation results calculated by an arbitrary calculation of combined the information P1a′, P2a′, . . . , Pna′ of the user A and P1b, P2b, . . . , Pmb of the user B and sends the first calculation results to the server, wherein the server correlates each of one or more of the first calculation results with an identification tag of the user B and stores one or more of the first calculation results and the identification tag of the user B; wherein the information terminal of the user C generates one or more second calculation results calculated by an arbitrary calculation of combined the information P1a″, P2a″, . . . , Pna″ of the user A and P1b″, P2b″, . . . , Pmb″ of the user B and sends the second calculation results to the server; wherein the server correlates each of one or more of the second calculation results with an identification tag of the user C and stores one or more of the second calculation results and the identification tag of the user C; wherein the server searches for a calculation result among one or more of the second calculation results which matches a calculation result of one or more of the first calculation results and send an identification tag which is correlated with the matching calculation result to the information terminal of the user B.

A server of another embodiment of the present invention comprises a data processor, the data processor receives one or more first calculation results calculated by an arbitrary calculation of combined information P1a′, P2a′, . . . , Pna′ (where n is an integer) of a user A and P1b, P2b, . . . , Pmb (where m is an integer) of a user B, one or more of the calculation results being generated in an information terminal of the user B, and correlates an identification tag of the user B with one or more of the first calculation results or each of one or more the first calculation results and stores the identification tag of the user B and one or more of the first calculation results, and receives one or more second calculation results calculated by the arbitrary calculation of combined information P1a″, P2a″, . . . , P1n′ of the user A, and correlates an identification tag of the user C with one or more of the second calculation results or each of one or more of the second calculation results and stores the identification tag of the user C and one or more of the second calculation results.

An information terminal of another embodiment of the present invention comprises: a calculation unit which generates a first calculation result group calculated by an arbitrary calculation of a part of or all of information P1a, P2a, . . . , Pna of a user A and a part of or all of information P1b′, P2b′, . . . , Pmb′ of a user B; a sending unit which sends the first calculation result group to a server, and; a receiving unit, wherein the server searches for a calculation result which matches the first calculation result group which is sent from the information terminal of the user A, the calculation result group being either a second calculation result group which is calculated by the arbitrary calculation of arbitrary combination of a part of or all of information P1a′, P2a′, . . . , Pna′ of the user A and information P1b, P2b, . . . , Pmb of the user B, the second calculation result group being correlated with an identification tag of the user B and stored in the server and sent by an information terminal of the user B, or a third calculation result group which is calculated by the arbitrary calculation of arbitrary combination of a part of or all of information P1a″, P2a″, . . . , Pna″ of the user A and information P1b″, P2b″, . . . , Pmb″ of the user B, the third calculation result group being correlated with an identification tag of the user C and stored in the server and sent by an information terminal of the user C, and by detecting a match between the first calculation result group and the second calculation result group or the first calculation result group and the third calculation result group receives an identification tag of the user B or the user C which is correlated with the matching calculation result, the identification tag of the user B or the user C being sent to the information terminal of the user A, or flag information, the flag information and the identification tag of the user B or the user C showing a match between the first calculation result group and the second calculation result group or the first calculation result group and the third calculation result group.

An information terminal of another embodiment of the present invention comprises: a calculation unit which generates a first calculation result group calculated by an arbitrary calculation of arbitrary combination of a part of or all of information P1b, P2b, . . . , Pmb of a user B and information P1a′, P2a′ . . . , Pna′ of a user A; a sending unit which sends the first calculation result group to a server, and; a receiving unit, wherein the server detects a match between a second calculation result group calculated by an arbitrary calculation of arbitrary combination of a part of or all of information P1a″, P2a″, . . . , P2a″ of the user A and P1b″, P2b″, . . . , Pmb″ of the user B, the information being stored in an information terminal of the user C and correlated with an identification tag of the user C and sent by the information terminal of the user C, and the first calculation result group which is received by the server from an information terminal of the user B, and the receiving unit receives either the identification tag of the user C which is sent to the information terminal of the user B, or flag information, the flag information and the identification tag of the user C showing a match between the first calculation result group and the second calculation result group.

### BRIEF DESCRIPTION OF THE DRAWINGS

FIG. 1 shows a drawing in which a black hat is trying spoofing in a system of an embodiment of the present invention.

FIG. 2 shows a block diagram of a server of an embodiment of the present invention.

FIG. 3 shows a block diagram of an information terminal o User A of an embodiment of the present invention.

FIG. 4 shows a block diagram of an information terminal o User B of an embodiment of the present invention.

FIG. 5 shows a block diagram of an information terminal o User C of an embodiment of the present invention.

FIG. 6 shows a flowchart for registering a hash value in an embodiment of the present invention.

FIG. 7 shows a flowchart for searching a user in an embodiment of the present invention.

FIG. 8 shows a flowchart for detecting a black hat in an embodiment of the present invention.

### DETAILED DESCRIPTION OF THE INVENTION

Embodiments of this invention are explained below in detail by referring to the drawings. Further, the following embodiment is simply an example for carrying out this invention, and the system, method, computer program, server, information terminal, operating system, middleware, information communication method, authentication method and application software of this invention is not limited to the following embodiment.

### Embodiment 1

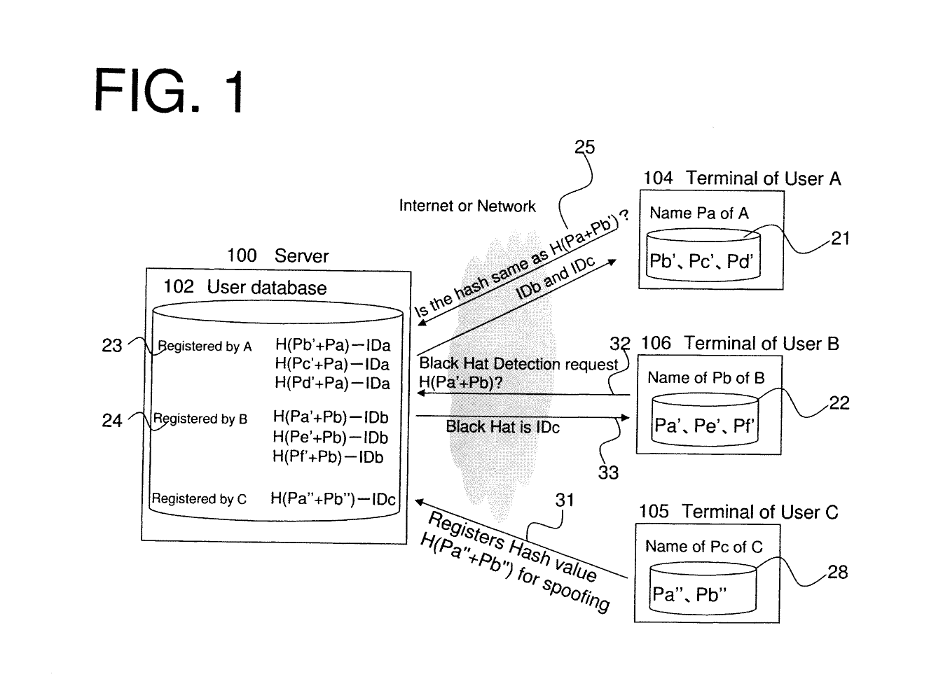

An embodiment of a black hat detection in a server, information terminal, communication terminal, system, authentication method, application software and middleware related to embodiment one of this invention are explained with the references to FIG. 1 to FIG. 8.

A system related to the embodiment 1 of the present invention includes a server 100, User A's terminal 104, and User B's terminal 106. In FIG. 1, User A's terminal 104 and User B's terminal 106 mentioned in the embodiment one, each of which may be an information terminal or a communication terminal, are shown as connected to server 100 via an intranet, an internet, LAN or are connected directly. An authentication method, application software and middleware related to the embodiment 1 of the present invention are installed in User A's terminal 104, User B's terminal 106, and server 100, and then the method of the embodiment 1 of the present invention is executed. Moreover, User C's terminal 105 is shown in FIG. 1 for explaining the embodiment 1 of the present invention. User C is a black hat who pretends to be User B when User A searches for User B.

As shown in FIG. 1, User A, B and C by using the respective terminals namely 104, 106 and 105 connected to the network, communicate or exchange information between specific individuals. For example, these are the users of specific network services such as e-mails, IP phones, network games, SNS, or chat services etc.

In FIG. 1, the personal information Pb′, Pc′, and Pd′ of acquaintances B, C, and D respectively are stored. Such personal information may be the name of each acquaintance. The personal information Pb′, Pc′, and Pd′ are known to User A, namely, stored in the memory unit 21 of the terminal 104 of User A. Further, the personal information Pa′, Pe′, and Pf′ of the acquaintances A, E, and F that are known to the User B, are stored in the memory unit 22 of the terminal 106 of User B. Moreover, the personal information Pa″ and Pb″ of Users A and B that are known to User C in some way are stored in the memory unit 28 of the terminal 105 of User C, who is a black hat.

The apostrophe sign ″″′ on the upper right side of each information (names, for example, in the embodiment 1) stored in the memory unit of respective terminals indicates that another user's information is stored in the terminal by the owner. For example, Pb′ in FIG. 1 is the name of User B that has been stored and saved in the memory unit of terminal 104 by User A. Moreover, Pb is the name of User B that has been stored and saved in the memory unit of terminal 106 by User B themselves. Though usually, Pb′=Pb holds, that may not be the case when the information stored on any terminal is wrong or old.

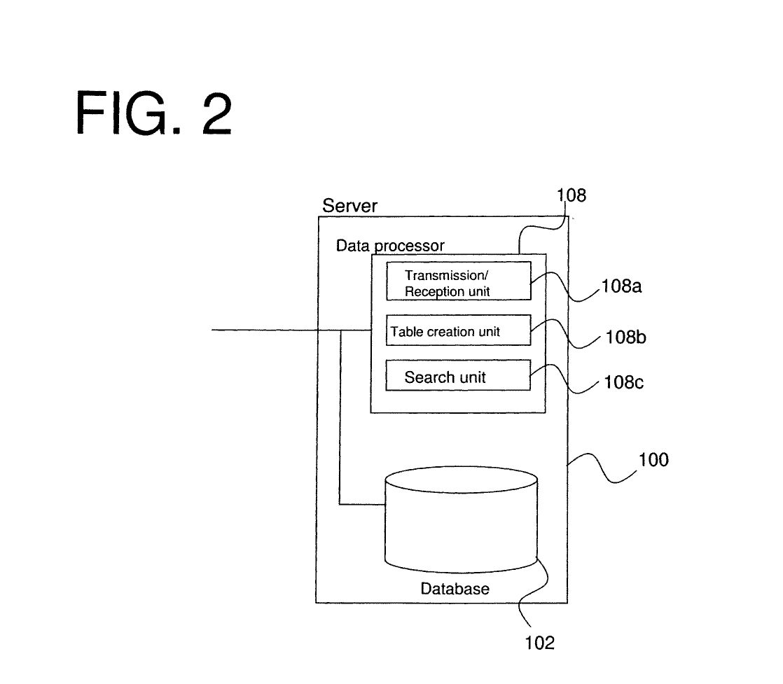

FIG. 2 shows a schematic configuration diagram of the server 100 related to the embodiment 1. The server 100 has the database 102 where information such as names etc. (of the users who are using the system of the present invention given in this embodiment) is stored and the data processor 108. The data processor includes the transmission and reception unit 108a, the table creation unit 108b and the search unit 108c.

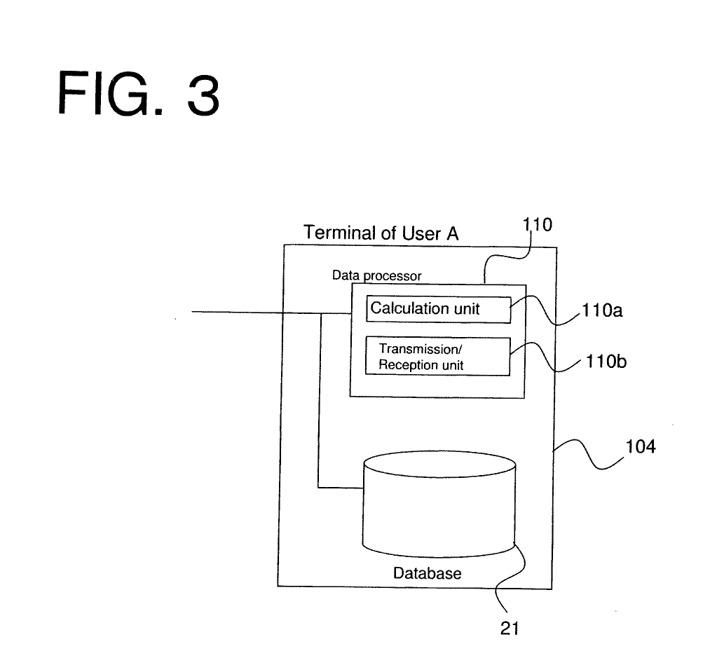

FIG. 3 shows a block diagram of User A's terminal 104 related to the embodiment 1. The terminal 104 has the database 21 where information such as names etc. (of other users who use the system of the present invention given in this embodiment) is stored and the data processor 110. A data processor includes the calculation unit 110a and the transmission and reception unit 110b.

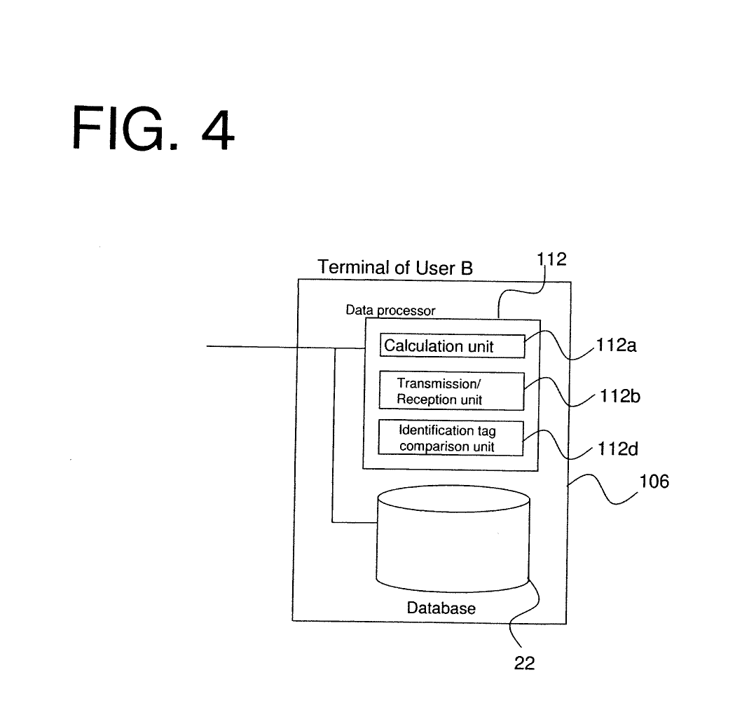

FIG. 4 shows a block diagram of User B's terminal 106 related to the embodiment 1. The terminal 106 has the database 22 where information such as names etc. (of other users who use the system of the present invention given in this embodiment) is stored and data processor 112. A data processor includes the calculation unit 112a, the transmission and reception unit 112b and the identification tag comparison unit 112d.

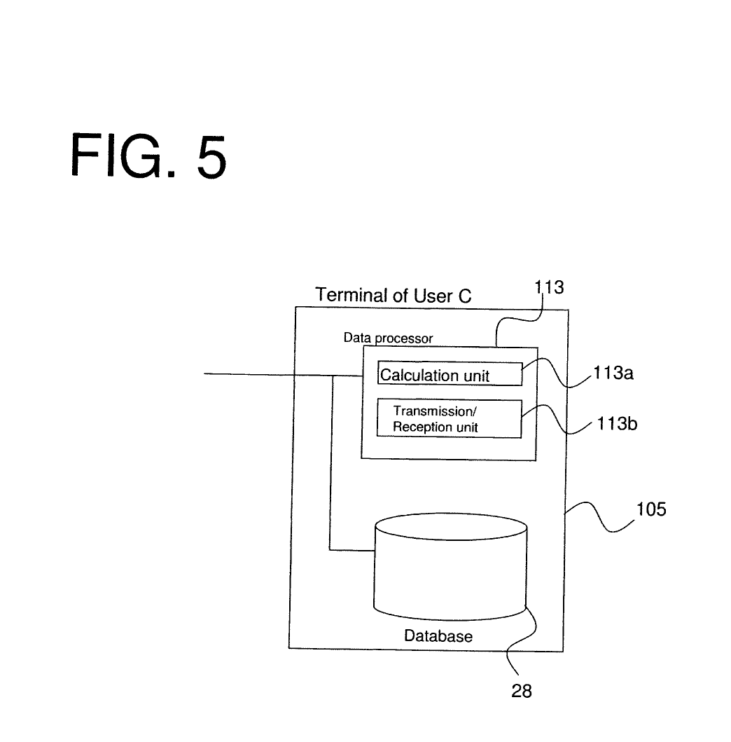

FIG. 5 shows a block diagram of User C's terminal 105 related to the embodiment 1. Similar to User A's terminal 104 and User B's terminal 106, the terminal 105 has the database 28 where information such as names etc. (of other users who use the system of the present invention given in this embodiment) is stored and data processor 113. A data processor includes the calculation unit 113a and the transmission and reception unit 113b.

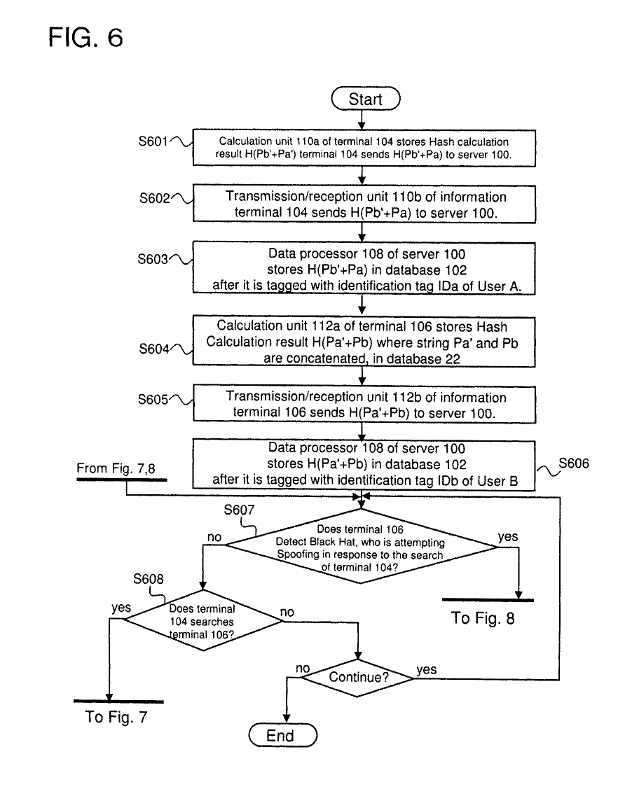

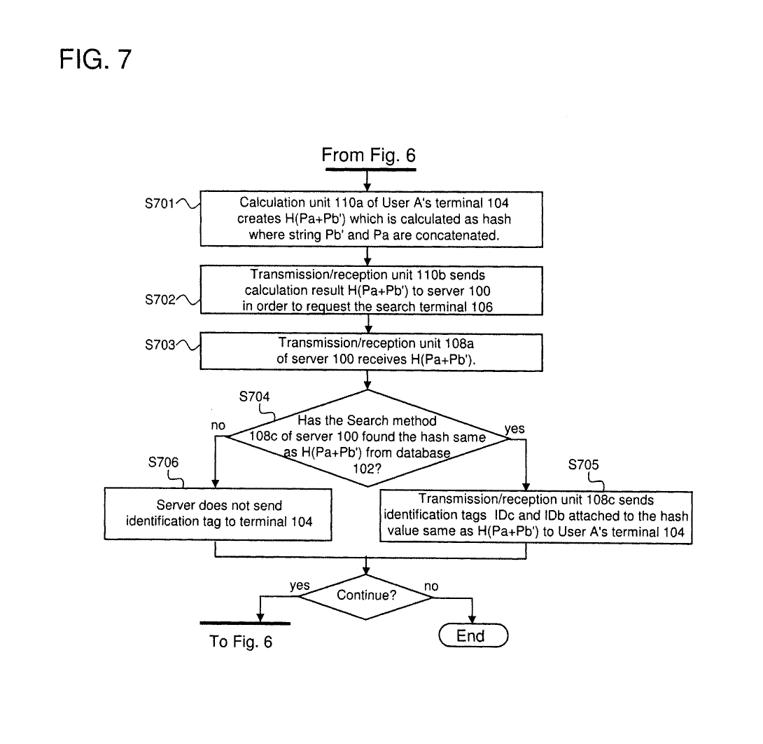

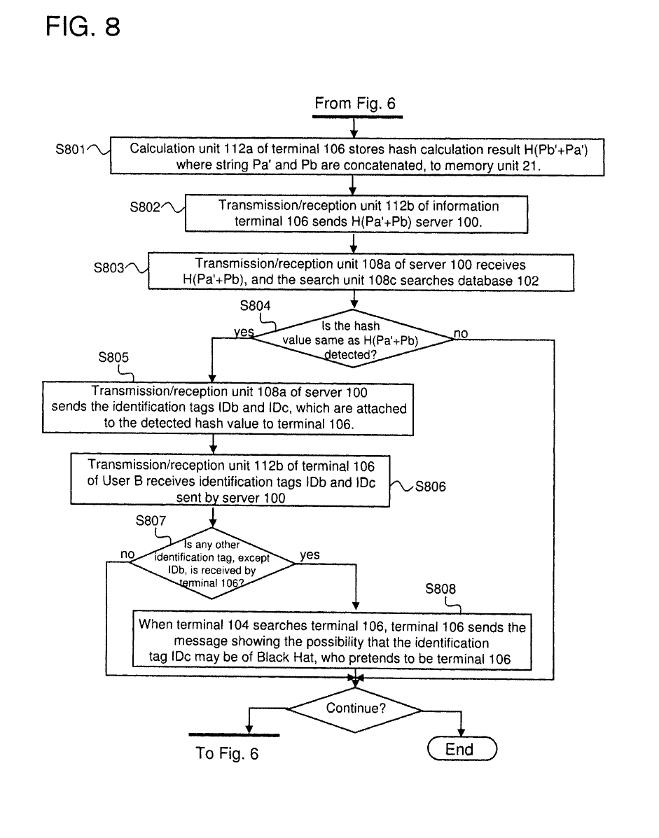

The method for searching User B's terminal 106 by User A's terminal 104 with the help of flowcharts given in FIG. 6 and 7 is described using an example below, where as mentioned above, User A stores the information of Users B, C, and D in the database 21 of the terminal 104, and User B stores the information of Users A, E, and F in the database 22 of the terminal 106. Further, by using the flowchart in FIG. 8, the method to detect the terminal 105 of User C, who is a black hat and pretends to be User B and tries to be searched as User B by User A, is described.

As shown in FIG. 1, in User A's terminal 104, calculation unit 110a generates Pb′+Pa by combining the character string Pb′ that denotes B and the character string Pa that denotes A, which are stored and retained in the database 21. Further, for this concatenated character string, the result H(Pb′+Pa) obtained by calculating with a hash function (for example, SHA-1 or MD-5 etc.) is stored and retained in the database 21 (Step S601). Here, the calculation result obtained after processing the concatenated character string by using the hash function H is expressed as H(Pb′+Pa). Similarly, in User A's terminal 104, the calculation unit 110a generates the combinations of every character string that shows the names of Users C and A, D, and A, and the results H(Pc′+Pa) and H(Pd′+Pa) that are obtained by calculations with the hash function are stored and retained in the database 21 (Step S601). Next, the transmission and reception unit 110 of terminal 104 of User A sends the calculation results H(Pb′+Pa), H(Pc′+Pa) and H(Pd′+Pa) to the server 100 of the network service provider (Step S602). The data processor 108 of the server 100 receives H(Pb′+Pa), H(Pc′+Pa), and H(Pd′+Pa) by the transmission and reception unit 108a. The table creation unit 108b of the server 100 registers calculation results (23) H(Pb′+Pa), H(Pc′+Pa), and H(Pd′+Pa) after associating it with the identification tag IDa for uniquely specifying A on this network service such as “A in this network service” etc., or with the information necessary for the connection with A and stores it in the database 102 (Step S603). The identification tag can be any information that can specify User A's terminal 104 on this network service. For example, it can be a numerical value assigned to all users including User A by the service provider beforehand so that it is not duplicated or information such as an e-mail address that is not same as that of other users of this network. The identification tag indicated in this embodiment and in the embodiments hereinafter is similar. Moreover, the calculations or data transmission and reception on the terminal 104 of User A and the server 100 may be processed by a computer program, middleware, or an application that runs on an operating system installed in the server 100 or the terminal 104.

In the embodiment 1 and the embodiment 2 given below, the calculation results by the hash function of a string combination of names of other users and User A, which are stored on User A's terminal 104 are used. However, the personal information used here not only includes the user's name, but also information such as the address, the age, the telephone number, the e-mail address, the occupation, the place of employment, the school of graduation, the birthplace, the public key, the private key etc. Moreover, Pa may be the name of A that is stored in the terminal 104 of A, and personal information having the same attribute ‘Name’ (such as Pb′, Pc′, and Pd′ are the names of B, C, and D respectively) of other users are stored in the terminal 104 of A. However, combinations of personal information having different attributes can also be used such as Pa is the name of A, Pb′ is the address of B, Pc′ is the telephone number of C, and Pd′ is the age of D. Generally, the personal information that is used here need not be personal identifiers, but it may be general information such as a password decided in advance by the users communicating.

In this embodiment, operations of string combinations of Pb′ and Pa are executed and the calculation result H(Pb′+Pa) by hash function is used. However, any calculation result F(Pb′, Pa) that is uniquely defined on the basis of Pb′ and Pa can be used instead. Such calculation F(Pb′, Pa) may be a reversible calculation. That is, Pb′ and Pa can be calculated from F(Pb′, Pa), or the calculation may be a non-reversible calculation, that is, Pb′ and Pa cannot be feasibly calculated from F(Pb′, Pa). Further, the calculation of F(Pb′, Pa) may be a commutative calculation, that is, F(Pb′, Pa)=F(Pa, Pb′) or a non-commutative calculation, that is, F(Pb′, Pa)≠F(Pa, Pb′). The hash operation H(Pb′+Pa) of a string combination used in the embodiments is simply one example which uses a non-commutative and non-reversible calculation from among the optional calculation F(Pb′, Pa). Also, the calculation result of a hash function of string combinations used in the embodiment 1 and in other embodiments given below may be the calculation result of any function that is described here.

Next, in FIG. 1, the calculation unit 112a generates the combination Pa′+Pb of the string Pa′ denoting the name of User A stored and retained in the database 22 and the string Pb denoting the name of User B stored and retained in the database 22 on the terminal 106 of User B. Further, the result H(Pa′+Pb) of a calculation by any hash function such as SHA-1, MD5, etc. is generated for this string combination and it is stored and retained in the database 22 (Step S604). The hash function H of the string combination that is calculated on the terminal 106 of B may be any hash function. However, it should be similar to the hash function H that is calculated on the terminal 104 of A. Similarly, in the terminal 106 of B, the calculation unit 112a generates the hash function result H(Pe′+Pb) and H(Pf′+Pb) of the string combinations of names such as E and B, F and B respectively. These three calculation results H(Pa′+Pb), H(Pe′+Pb), and H (Pf′+Pb) are stored and retained in the database 22 (Step S604). Then, the transmission and reception unit 112b on the terminal 106 of User B sends the calculation results H(Pa′+Pb), H(Pe′+Pb) and H(Pf′+Pb) to the server 100 of the network service provider (S605). Data processor 108 of the server 100 receives the calculation results H(Pa′+Pb), H(Pe′+Pb) and H(Pf′+Pb) in the transmission and reception unit. The table creation unit of the server 100 registers the calculation results (24)H(Pa′+Pb), H(Pe′+Pb), and H(Pf′+Pb) by associating them with the identification tag IDb to specify the terminal 106 of B on this network service such as a network service ID or with the information required to contact B, and stores and retains it in the database 102 (Step S606). In User B's terminal 106, a hash value can be calculated by a computer program, middleware, or an application program that runs on the operating system installed in the terminal 106.

Here, in the embodiment 1, the calculation results by a hash function of a string combination of names of other users and User B that are stored on User B's terminal 106 may be used. However, the personal information used here need not be the user's name, but it can also be information such as the address, the age, the telephone number, the e-mail address, the occupation, the place of employment, the school of graduation, the birthplace, etc. Moreover, here, Pb is the name of B that is stored in the terminal 106 of B, and the personal information of the same attribute such as ‘Name’ is used. For example, Pa′, Pe′ and Pf′ may be the names of A, E, and F respectively that are stored in the terminal 106 of B. In addition, combinations of personal information of different attributes can be used such that Pb′ may be the name of B, Pa′ may be the address of A, Pe′ may be the telephone number of E, and Pf′ may be the occupation of F. Further, the information used here is called personal information and does not need to be information that can identify the user. This information may be general information such as a password decided in advance by the users communicating.

In this situation, User B can always detect the black hat who is spoofing on the terminal 106 (Step S607) as explained below. However, a method (Step S608) to detect User B's terminal 106 through the server 100 by User A's terminal 104 and its effects are described in the embodiment 1 with reference to FIG. 7. Subsequently, with reference to FIG. 8, the steps to detect the terminal 105 of User C, who is pretending to be User B's terminal 106, are described in step S607 mentioned above.

Referring to FIG. 7, the calculation unit 110a generates the result H(Pa+Pb′) where hash operations are executed for the string combinations of names of A and B on User A's terminal 104 when User A tries to search for User B (Step S701). The hash operation H that is executed on terminal 104 of User A may be any operation. However, it should be similar to the operation that is used at Step S604 mentioned above in order to register User A's terminal 104. Then, the transmission and reception unit 110b of the terminal 104 of UserA sends the calculation result H(Pa+Pb′) to the server 100 of the network service provider and requests for the search (25) (Step S702). The calculation result H(Pa+Pb′) that is sent from User A's terminal 104 is received through the transmission and reception unit 108a of the data processor 108 in the server 100 (Step S703). Then, the search part 108c of the data processor 108 searches the calculation result H(Pa+Pb′) that is sent from terminal 104 and the calculation result that is registered in the corresponding database 100 (Step S704). In the example shown in FIG. 1, H(Pa′+Pb) that is registered by User B's terminal 106 and H(Pa″+Pb″) that is registered by User C's terminal 105 are the two types of hash values that are equivalent to H(Pa+Pb′) for which a query is received by the server 100 from User A's terminal 104. Therefore, in response to the search request from UserA's terminal 104, the search unit 108c in the server 100 detects whether the hash value H(Pa′+Pb) registered by User B's terminal 106 in the database 102 and H(Pa″+Pb″) registered by User C's terminal 105 matches with the calculation result H(Pa+Pb′) that is sent from User A's terminal 104 (Step S704), and sends the identification tags IDb and IDc associated with these two hash values on the database 102, to User A's terminal 104 (Step S705). As a search result to the database 102, the server 100 does not send the identification tag to User A's terminal 104, unless a hash value matching with H(Pa+Pb′), for which a query is received from User A's terminal 104, is detected (Step S706).

In the example shown in FIG. 1, when User C, who is a black hat, pretends to be User B when User A's terminal 104 searches for User B's terminal 106 on the database of the server, the hash value H(Pa″+Pb″), which is calculated from Pa″ and Pb″, is registered, the names of User A and User B in the database 102 of the server 100. Therefore, at Step S705 mentioned above, two identification tags IDb and IDc are received by User A's terminal 104. When there is no spoofing by User C, who is a black hat or if H(Pa″+Pb″) tagged with identification tag IDc of User C is not stored in the database 102 of the server 100, only the identification tag IDb of User B, who is searched for by User A is sent to User A's terminal 104 at Step S705 mentioned above. The advantages of the method in an embodiment of the present invention over the conventional method are explained here considering that there is no spoofing by User C first. Further, according to the present invention, the black hat detection method and its advantages when there is spoofing by User C, the black hat, is explained below after describing the four advantages of an embodiment of the present invention when there is no spoofing.

When there is no spoofing by User C, the following are the four advantages according to the methods of an embodiment of the present invention compared to a conventional method. These four advantages are also valid when there is spoofing by User C.

The first advantage of an embodiment of the present invention is that the maintenance of confidentiality is easy in a search service when a non-reversible calculation such as a hash-function operation of a string combination such as referred to in the embodiment 1 is used. According to the method or the system of an embodiment of the present invention, the calculation result, where the personal information of two users is processed by using a non-reversible calculation, is registered on the server of a network service provider. When a non-reversible calculation is used, a searcher can search even if no personal information is disclosed by the user, who is being searched, while in a conventional search method, a user cannot search when personal information is not registered on the server of a network service provider. Moreover, a network service provider can provide a search method without maintaining the personal information of a user. In the example shown in FIG. 1, the information to be disclosed to a service provider as the information for searching B by another user is not the personal information of B herself/himself, but it is a calculation result H(Pa′+Pb) by a hash function that concatenates the names of A and B. No personal information of A or B can be calculated from this hash value. However, personal information can be secured by using the system or the method of an embodiment of the present invention. In the system or the method of an embodiment of the present invention, when a reversible calculation is used and when personal information of a user is restored from the information registered on the server of a network service provider, the security protection level is low as compared to the case where a non-reversible calculation is used. The remaining three advantages regarding use of reversible calculations are as shown below.

The second advantage of an embodiment of the present invention is that a user can prevent from being searched by an unwanted/undesirable user. According to the conventional method, since all users can search the personal information registered on the server of a network service provider, unwanted third users can search the information of the user, and therefore there is a risk of an unwanted third user obtaining the personal information registered by the user who is being searched. On the other hand, according to the system or the method of an embodiment of the present invention, a user cannot be searched by a user other than the user who is registered in combination with their own name since the hash of a combination of their own name and name of acquaintances and users who are allowed to search them, are pre-registered. In the example shown in FIG. 1, only the users B, C, and D can search User A. Other users can not search User A on the network.

The third advantage of an embodiment of the present invention is that a highly accurate search is available even if a user uses information with a low level of uniqueness. In the conventional methods, for example, if a user searches by name in which the same name has a high possibility of duplicate hits, in other words, if a user searches by personal information with a low level of uniqueness, the user may detect many matches having the same name and the user is not able to identify the actual search object. Therefore, personal information such as an e-mail address, a phone number, and a social insurance number, which will have less duplicate hits, is usually used for the search. However, information, which has less duplicate hits, is even more confidential than a name etc. and is registered on the server of a network service provider. Hence, there is a risk of information leakage in allowing a search to unspecified users. In the system and the method of an embodiment of the present invention, the hash value of the combination of two users' personal information is registered on the server of the network service provider and this hash value is used for a search. Hence, even though personal information such as a name, which may have a low level of uniqueness and which may have a high possibility of duplicate hits, is used by several users for searching, the possibility of duplicate hits decreases. For example, although there are many users which have the same name as User B, the probability of having many combinations of A and B among the combinations of all users is definitely low as compared to the probability of having the same name as User B. Therefore, an effective search is possible even if a user uses information such as a name which has a low level of uniqueness and is known to everyone.

In addition, in the system and the method in an embodiment of the present invention, as long as a non-reversible calculation as stated above is used, even if information with a high level of uniqueness, that is, a high level of secrecy, is used in a search, because the calculation result which is a combined non-reversible calculation becomes the object of a search, personal information cannot be obtained from this search and thus the search is safe. For example, in the conventional methods as well as the method of an embodiment of the present invention, duplicate hits can be eliminated by using personal information such as an e-mail address, an address, and a phone number. However, the method of an embodiment of the present invention secures a much higher level of confidentiality as compared to the conventional methods.

Nevertheless, in the search unit 108c of the server 100, if several matches of a calculation result are detected due to the duplication of personal information such as the same name, there is another method where the users, who give maximum answers by using the calculation result of combinations such as the city, the sex, and the affiliation in addition to the name, are presumed as search objects. For instance, B registers the calculation results H(Pa′+Pb), H(Qa′+Qb), and H(Ra′+Rb) of a hash function H where the strings of personal information of A and B are concatenated, for the name P, the sex Q, and the affiliation R respectively on the database 102 of the server 100. Thus, when A tries to search for B, she/he requests the server 100 for H(Pa+Pb′), H(Qa+Qb′), and then H(Ra+Rb′). In the search unit 108 of the server 100, even though the calculation results of the attributes P, Q, and R do not match, in other words, even if H(Pa′+Pb)=H(Pa+Pb′), H(Qa′+Qb)=H(Qa+Qb′), and H(Ra′+Rb)=H(Ra+Rb′) do not hold, it is possible for A to search for B, whom A tries to communicate with on the network service. This is possible when A assigns weight factors α, β, γ respectively to attributes P, Q, and R and uses these factors to calculate a total weight of the number of matches of the calculation results.

The fourth advantage of an embodiment of the present invention is that, as compared to the conventional methods, spoofing becomes difficult for a malicious third party (a black hat). Spoofing by a black hat was easy in the conventional methods, wherein the personal information of the user who is being searched is registered on the server and the searcher sends a request to the server to search that personal information. In the conventional method, User B registers their name Pb on the server and User A, who knows the name of User B, searches User B by requesting Pb to the server. In this case, the name of User B is the only information that User C, a black hat, has to pretend to be User B. In other words, User C can freely choose the personal information to be registered on the server. Thus, User C is able to register the name Pb of User B instead of her/his own name. This enables User C to pretend to be User B when User A searches User B. However, according to the method of an embodiment of the present invention, in order to pretend to be User B with respect to a search request from User A, User C, a black hat, has to know the fact that User B, whose name is Pb, knows User A, whose name is Pa, and User B has accepted the search request from User A. In short, in this situation, User C, a black hat, must register the hash value H(Pa′+Pb) where the strings of the names of Users A and B are concatenated, to pretend to be User B. Thus spoofing is more difficult for a black hat as compared to the conventional methods in which the personal information of the user who is being searched is directly registered on the server.

However, even though an embodiment of the present invention has this fourth advantage stated above, spoofing by a black hat cannot be prevented completely. Spoofing is possible in the cases where User C, a black hat, knows the names or the relationship between Users A and B.

For example, it is well known that the 43rd President of the U.S., George W. Bush and his father, the 41st President of the U.S., George H. W. Bush, know each other. Also, it is quite obvious that George W. Bush will accept being searched by George H. W. Bush. In such a situation, even in the method of an embodiment of the present invention, a black hat can register the hash value where the strings of George W. Bush and George H. W. Bush are concatenated, on the server 100 and then pretend to be George W. Bush in response to the search request from George H. W. Bush. In fact, in the embodiment 2, which is explained below, it is described that registering the hash value of a combination of various personal information makes it much more difficult for a black hat to pretend to be George W. Bush. However, as described in the embodiment 1, even a simple method as shown below, in which a hash value where strings of names are concatenated is registered, can effectively eliminate spoofing by a black hat.

Referring back to FIG. 1, Pa″, which is the name of User A, and Pb″, which is the name of User B are stored in the memory unit 28 of C's terminal 105, who is a black hat. Therefore, even in the method of an embodiment of the present invention, spoofing is possible when searching User B's terminal 106 by using User A's terminal 104. As is stated above, as a result of each step in FIG. 6 and FIG. 7, User A's terminal 104 obtains two identification tags, namely, IDb and IDc (step S705). However, User A's terminal 104 cannot distinguish between User B's terminal 106 to be searched and, the terminal 105 of User C, who is a black hat. Here, the black hat, User C, is successful in spoofing of User A. If User B's terminal 106 did not register the value H (Pa′+Pb) to the server 100 at the previous step S605, the problem becomes more serious, since User A recognizes the identification tag IDc of the black hat User C, as the identification tag of User B, who is being searched by User A. A method to detect that black hat C is spoofing User B's terminal 106, which is to be searched, is mentioned below.

Referring to FIG. 1, the black hat User C knows both the names of Users A and B, and Pa″ as well as Pb″ are stored in the database 28 of the terminal 105. User C aims at pretending to be User B during a search by User A's terminal 104 for User B's terminal 106. On User C's terminal 105, calculation unit 113 generates the hash value H(Pa″+Pb″) of the string concatenation of Pa″ and Pb″ saved in the database 28. The transmission and reception unit 113b sends this to the server 100, and the transmission and reception unit 108a of the server 100 receives it. And then it is stored in the database 102 after associating it with this received hash value H(Pa″+Pb″) and the identification tag IDc of User C, and stored in the database 102.

Therefore, as is mentioned regarding to Step S705, as a result of searching User B's terminal 106 by User A's terminal 104, User A receives identification tags IDb and IDc. In this situation, UserA's terminal 104 cannot distinguish which is User B's terminal 106 which is being searched by User A.

However, by using the method of an embodiment of the present invention, User A's terminal 104 can find out that User B is spoofing User C's terminal which has the identification tag IDc for searching from User A's terminal 104. Referring to FIG. 8, the calculation unit 112b of terminal 106 of User B generates the hash value H(Pa′+Pb), and stores it in the memory unit 21 of the terminal 106 of User B (Step S802). Then, a search (32) is requested by sending this hash value H(Pa′+Pb) to the transmission and reception unit 110b (Step S802), for detecting a black hat. The transmission and reception unit 108a of the server 100 receives the request, and as a result of searching the database 102 (Step S803) by using the search unit 108c, if there is hash value similar to the previous one (Step S804), the identification tags associated with each matching hash value are sent to User B's terminal 106 through the transmission and reception unit 108a (Step S805). On the other hand, an identification tag sent through the server by the transmission and reception unit 122a, is received in User B's terminal 106, and then, the identification tag comparison unit 112d verifies whether there is an identification tag other than the identification tag IDb of User B's terminal 106 (step S807). If an identification tag other than IDb is found, it is highly possible that the identification tag is a black hat who pretends to be User B's terminal 106 in a search of User B's terminal 106 via User A's terminal 104.

In the present embodiment, the identification tag comparison unit is on User B's terminal 106. On the terminal 106, an identification tag sent from the server 100 is compared with the identification tag IDb of User B. On the basis of this search result obtained at the previous Step S805, the method to compare the identification tag with the identification tag IDb of User B's terminal 106, who sends the request, can be saved on the server 100. In this case, transmission and reception method 108a can send only the identification tag which is identified as the identification tag of a black hat after comparing with the identification tag IDb by the identification tag comparison unit, to User B's terminal 106.

By using this method, if a black hat is found by the recipient of disclosed information, the transmission and reception unit 112b of the terminal 106 of User B. who is the recipient of disclosed information sends the message that ‘the terminal of identification tag IDb is being spoofed’ to User A's terminal 104 (Step S808). This messages may be displayed on the display unit of the terminal 104 of User A, prompting the user to take precaution. Or the transmission and reception unit 108a of the terminal 106 of User B sends a command to the server 100 to delete H(Pa″+Pb″), which is registered and associated with the identification tag IDc of User C, who is a black hat. By sending this command, the hash value H(Pa″+Pb″) registered and associated with the identification tag IDc by User C, who is a black hat, will be deleted from the database 102 of the server 100. Then, a user can eliminate spoofing by a black hat in future. Each user of this communication service can regularly execute a search for detecting a black hat on the server 100 by using this method.

Moreover, in the present embodiment, the transmission and reception unit, the calculation unit, the identification tag comparison unit on each terminal and the transmission and reception unit, the table creation unit, the search unit on the server can be processed by using an operating system, a middleware or an application software that is operating on hardware of each terminal or server.

However, steps for black hat detection shown as steps S801 to S808 mentioned above can be executed anytime separately from the steps for the hash value registration described as Steps S601 to S606 mentioned above and steps for hash value search described as Steps S701 to 706 (Step S607).

According to the method of an embodiment of the present invention, in addition to the four effects described above, the fifth effect of an embodiment of the present invention is that a user's terminal wherein a black hat is spoofing can easily detect the black hat. Suppose User C, a black hat, pretends to be User B to User A, the searcher. However, the advantage of the method of an embodiment of the present invention is that User B, who is being searched by User A, can detect that the black hat is spoofing her/him. Moreover, the identification tag of the black hat can be obtained from the server 100.

In an embodiment of the present invention, a non-commutative, non-reversible calculation such as a hash function of a string combination of names is used as an example. However, as mentioned above, this may be any calculation F. Generally, when the calculation used here is non-commutative and when User A's terminal 104 searches for User B, the information of A and personal information of B that is stored on User A's terminal 104, and the information of B and personal information of A that is stored on User B's terminal 106, are both correct. In other words, when Pa′=Pa and Pb′=Pb, the search unit 108c of the server 100 can detect the calculation result F(Pa″, Pb″) registered by User C, a black hat, by searching the calculation result tagged with an identification tag other than the identification tag IDb of User B in response to the black hat detection request 32, that is, H(Pa′+Pb) search request sent from User B's terminal 106 to the server 100.

When the calculation F used here is commutative and when User A's terminal 104 searches for User B, the information of A and personal information of B that is stored on User A's terminal 104, and information of B and personal information of A that is stored on User B's terminal 106, are both correct. In other words, when Pa′=Pa and Pb′=Pb, F(Pa″, Pb″) is sent to the server 100 by User C, who is a black hat, and F(Pa″, Pb″) is stored and associated with the identification tag IDc of User C in the database 102. F(Pb′, Pa) is sent to the server 100 by User A and F(Pb′, Pa) is stored and associated with the identification tag IDa of User A in the database 102. Then, F(Pa″, Pb″) and F(Pb′, Pa) are equal. In this case, in response to a search request to the server 100 of a calculation result equivalent to the black hat detection request 32 from User B's terminal 106, that is F(Pa′, Pb), both the calculation result F(Pa″, Pb″) tagged with the identification tag IDc of User C, a black hat, and F(Pb′, Pa) tagged with identification tag IDa of User A are returned to User B in addition to the calculation result F(Pa′, Pb) registered on the server 100 at Step S605 mentioned above. In other words, the black hat cannot be detected by this search request, since both User C, the suspected black hat, and User A, stored in the database 102 of the server 100 searched by User B, are detected. However, if the identification tag IDa of User A is stored in the database of User B's terminal 106, according to the search result of the black hat detection request 32, it can be determined that among the identification tags IDc and IDa of the users suspected as black hats mentioned above, IDa is not a black hat with the help of the identification tag comparison unit 112d present on the terminal 106 of User B. Therefore, User C having the identification tag IDc can be suspected as a black hat according to an elimination method.

As mentioned above, to establish communication between the terminal 104 of A and the terminal 106 of B, the identification tag IDb of B on this network service or required information to contact with B is notified from the server 100 of the service provider to the terminal 104 of A. A P2P connection 28 between the terminal 104 of A and the terminal 106 of B can be established. A connection between the terminal 104 of A and the terminal 106 of B can also be established through a connection server of a different network service provider.

In an embodiment of the present invention, the calculation result, that is, a hash value of the combination of personal information having the same attribute ‘Name’ such as the name of A stored in A's terminal and the name of B is used as the information H(Pa+Pb′) that is inquired to the server 100 by the terminal 104 of A. However, the hash value of combinations of personal information having different attributes can also be inquired to the server 100 such as Pa is the telephone number of A, Pb′ is the address of B. Further, the information used here is called personal information but it need not be restricted to the information that can identify a user. It can be general information such as a password decided in advance by the users communicating.

### Embodiment 2

In the embodiment 1, which is mentioned above, a result where single personal information of a searcher, who is allowed to search by the user being searched, and single personal information of the user, being searched, is registered on the server 100 of a network service provider and that information is searched by the searcher. In the embodiment 2, a calculation result of any combination of any information of a searcher, who is allowed to search by the user being searched, and any information of the user who is being searched, is registered on the server 100 of the network service provider. A general method is described in which a searcher inquires to the server 100 about the calculation result of any combination of the personal information of the user who is being searched, and personal information of the searcher herself/himself. In addition, the same symbols are assigned for the constituents similar to the system and method of an embodiment of the present invention related to the embodiment 1, therefore they are not explained again.

For example, a list of personal information of User A is assumed as P1a, P2a, . . . , Pna (where n is an integer). A list of personal information of User B is assumed as P1b, P2b, . . . , Pmb (where m is an integer). For example, P1a is the name of User A, P2a is the address of User A, and P3a is the telephone number of User A, and so on. And P1b is the name of User B, P2b is the address of User B, P3b is the telephone number of User B, and so on. Here, for example, symbols having the same suffix such as P1a and P1b may be the personal information of the same attribute or the personal information of a different attribute. Further, the information used here is called personal information and it need not be the information that can identify a user. It can be general information such as a password decided in advance by the users communicating.

The list of personal information P1a, P2a, . . . , Pna of User A and the list of personal information P1b′, P2b′, . . . , Pmb′ of User B are stored in the database 21 of the terminal 104 of User A. Personal information P1b, P2b, . . . Pmb of User B and personal information P1a′, P2a′, . . . , Pna′ of User A is stored in the database 22 of the terminal 106 of User B. The number or the type of the personal information of User A and User B can vary. Further, m=n or m≠n. The number of pieces of personal information of A stored on User A's terminal 104 and User B's terminal 106 may be the same or different. Similarly, the number of pieces of personal information of B stored on User B's terminal 106 and User A's terminal 104 may be the same or different.

Here, similar to the embodiment 1, an apostrophe ″″′ on the upper right side of each piece of information indicates the information of other user than the owner of the terminal is stored in the terminal. For example, in FIG. 1, if P1a and P1b are considered as names, P2a and P2b as addresses, and P3a and P3b as company names, P1b′ indicates the name of B stored in the terminal 104 by A. Further, for example, P2b indicates the address of B stored in the terminal 106 by B herself/himself. Though usually P1b′=P1b and P2b′=P2b, if the information stored in any terminal is wrong or old, that may not be the case.

Here, referring to the flowcharts in FIG. 6 and FIG. 7 again, the method to search for User B's terminal 106 by UserA's terminal 104 is described. Further, referring to FIG. 8, the method to detect the terminal 105 of User C who is a black hat and pretends to be User B and searches for User A by User B's terminal 106, is described. In the embodiment 1, the terminal 106 of User B, who is being searched, registers the hash value H(Pa′+Pb) of combination of their own name Pb and Pa′, which is the name of User A in the database 102 of the server 100. Further, User A's terminal 104 sends a query H(Pa+Pb′) to the server 100 and User B is searched by User A. Further, User B, who is being searched, detects the existence of the black hat by searching whether it is the hash value correlated with the value other than identification tag IDb of User B from H(Pa′+Pb) registered on the server. Similarly, in the embodiment 2 also, User A searches User B by using similar steps and detects the black hat. However, the point of difference from the embodiment 1 is, in the embodiment 1 mentioned above, the hash value of a set of combinations of information of a searcher and the user who is being searched, is used for a search, and in the embodiment 2, the hash value of any combination of the information of a searcher and the user who is being searched, is used. Here, an explanation is omitted since this step is similar to that of the step shown in FIG. 6, FIG. 7, and FIG. 8 shown in the embodiment 1. Moreover, in the embodiment 1, though the hash operation of a character string combination that is easy to understand is used as an example, in the example shown in the embodiment 2, arbitrary operation F in which personal information is considered as a variable is used. Consequently, in the embodiment 2, as shown in FIG. 2, an example is described by replacing the notation of the hash operation of a character string combination such as H(Pb′+Pa) with F (Pb′, Pa) where the arbitrary function F is used.

Similar to the embodiment 1, the arbitrary operation F used here can be a reversible operation or a non-reversible operation. As mentioned before, when the case where a reversible operation is used, among the effects of the embodiment 1, a lower level of confidentiality is achieved compared with the case where a non-reversible operation is used. However, the other effects remain unchanged. Further, the arbitrary function F used here may be commutative or non-commutative for variables to each of which personal information is substituted.

In the User A's terminal 104, the calculation unit 110a calculates the personal information P1b′, P2b′, . . . , Pmb′ of B stored in the database 21 and the personal information P1a, P2a, . . . , Pna of A herself/himself stored in the database 21 by using arbitrary operations F and stores it in the database 21. Any permutation and combination of personal information of User B and of User A themselves is possible for the calculations on User A's terminal 104. Thus, the combinations of personal information of B and A are (P1b′, P1a), (P2b′, P1a), (P1b′, P2b′, P1a, P2a), . . . , (P1b′, P2b′, . . . , Pmb′, P1a, P2a, . . . , Pna), etc. and more than one operation from these combinations is executed in the calculation unit 110a of the terminal 104 of A, for example, F (P1b′, P1a), F (P2b′, P1a), F (P1b′, P2b′, P1a, P2a), . . . , F (P1b′, P2b′, . . . , Pmb′, P1a, P2a, . . . , Pna) and it is stored in the database 21 (Step S601).

In reality, personal information of B that is stored and retained in the database 21 on User A's terminal is less than the information P1a, P2a ^{. . .} Pna of A herself/himself on A's terminal. For example, a number of pieces of information of A such as the name, the address, the telephone number, the home town, etc. is stored and retained in the database 21 of User A's terminal. However, information of B, who is another user, is limited to the name and the telephone number only. In such a case, any combination of personal information of A and B on User A's terminal can be generated from the personal information stored in the database 21 of A's terminal. Further, it is not necessary to combine all the personal information of A and B stored in the database 21 of User A's terminal. User A can select any combination.

Moreover, when only a part of information of A is stored and retained in the database 21 of A's terminal, the personal information of A and B can be combined arbitrarily among the information stored and retained in the database 21 on A's terminal. For example, in the state where only the name and the telephone number of A among A's personal information and only the address of B among B's personal information is stored and retained in the database of A's terminal, any combination of information of A and B that is available on the terminal 104 of A such as a combination of A's name and B's address is possible.

Then, the transmission and reception unit 110b on A's terminal 104 sends the calculation results F(P1b′, P1a), F(P2b′, P1a), F(P1b′, P2b′, P1a, P2a) , . . . , F(P1b′, P2b′, . . . , Pmb′, P1a, P2a, . . . , Pna), etc. based on any combination selected here to the server 100 of the network service provider (Step 602). The server 100 receives the calculation results F(P1b′, P1a), F(P2b′, P1a), F(P1b′, P2b′, P1a, P2a), . . . , F(P1b′, P2b′, . . . , Pmb′, P1a, P2a, . . . , Pna), etc. based on any combination selected on User A's terminal 104 by using the transmission and reception unit 108a. The table creation unit 108b registers as (23) the calculation results F(P1b′, P1a), F(P2b′, P1a), F(P1b′, P2b′, P1a, P2a), . . . , F(P1b′, P2b′, . . . , Pmb′, P1a, P2a, . . . , Pna), etc. that are received after associating with the identification tag IDa of the network server of A or with the information required for connection, and stores and retains it in the database 102 (Step S603). Further, the calculation or the data transmission and reception may be processed by any function on the server 100 and the terminal 104 of A by using a computer program, a middleware, and application that runs on an operating system installed on the server 100.

Similarly, the hash value creation unit 112a on the terminal 106 of User B selects one or more combinations of personal information P1a′, P2a′, . . . , Pna′ of A stored and retained in the database 22 and personal information P1b, P2b, . . . , Pnb of B stored and retained in the database 22. Here, for example, symbols having the same numbers such as P1a and P1b may be personal information of the same or different attribute. Generally, the information used here is called personal information and it may not be the information that can identify uniquely a user. It may be general information such as a password decided in advance by the users communicating. Any permutation and combination of personal information of User B and User A themselves is possible for the calculations on User A's terminal 104. Thus, the combinations of personal information of A and B are (P1a′, P1b), (P2a′, P1b), (P1a′, P2a′, P1b, P2b) . . . (P1a′, P2a′, . . . , Pna′, P1b, P2b, . . . , Pnb), etc. and among these combinations, any combination can be selected in the calculation unit 110a of the terminal 104 of B.

Generally, personal information of B stored and retained in database 22 on User B's terminal is less than the personal information P1b, P2b, . . . , Pnb of B herself/himself on B's terminal. For example, a number of pieces of information of B such as the name, the address, the telephone number, the home town, etc. is stored and retained in the database 22 of User B's terminal. However, information of A who is another user, is limited to the name and the telephone number only. In such a case any combination of personal information of A and B on User B's terminal can be generated from the personal information stored in the database 22 of User B's terminal. Further, it is not necessary to combine all the personal information of A and B stored in the database 22 of B's terminal. User B can select any combination.

Moreover, when only a part of the information of B is stored and retained in the database 22 of B's terminal, a part of the personal information of A and B can be combined arbitrarily. For example, in the state where only the telephone number of B from B's personal information and the address of A from A's personal information is stored and retained in the database on B's terminal, a unique combination such as the telephone number of A and the address of B is possible.

In the terminal 106 of B, the calculation unit 112a generate the calculation results F(P1a′, P1b), F(P2a′, P1b), F(P1a′, P2a′, P1b, P2b), . . . , F(P1a′, P2a′, . . . , Pna′, P1b, P2b, . . . , Pnb) calculated by using any operation F based on the string (P1a′, P1b), (P2a′, P1b), (P1a′, P2a′, P1b, P2b), . . . , (P1a′, P2a′, . . . , Pna′, P1b, P2b, . . . , Pnb) combined according to the combination selected here, and retains it in the database 22 (Step S604). Further, the transmission and reception unit 112b of B's terminal 106 sends the calculation results F(P1a′, P1b), F(P2a′, P1b), F(P1a′, P2a′, P1b, P2b), . . . , F (P1a′, P2a′, . . . , Pna′, P1b, P2b, . . . , Pnb) based on any combination selected here, to the server 100 of the network service provider (Step S605). Through the transmission and reception unit 108b, the data processor 108 of the server 100 receives the calculation results F(P1a′, P1b), F(P2a′, P1b), F(P1a′, P2a′, P1b, P2a), . . . , F(P1a′, P2a′, . . . , Pna′, P1b, P2Bb, . . . , Pnb), etc. sent by User B's terminal 106. The table creation unit 108b registers as (24) calculation results F(P1a′, P1b), F(P2a′, P1b), F(P1a′, P2a′, P1b, P2b), . . . , F(P1a′,P2a′, . . . , Pna′,P1b,P2b, . . . ,Pnb) etc. after associating with the identification tag IDb on this network service of B or with the information necessary for a connection with B and stores it in the database 102 (Step S606). Moreover, the calculations or the transmission and the reception by any function on User B's terminal 106 may be processed on a computer program, a middleware, or application that runs on an operating system installed in the terminal 106.

In this situation, User B can always detect a black hat who is spoofing as the terminal 106 (Step S607). However, a method (Step S608) to search for User B's terminal 106 through the server 100 by User A's terminal 104 is described in the embodiment 2 by using FIG. 7. Subsequently, referring to FIG. 8, the steps to detect the terminal 105 of User C, who is pretending to be User B's terminal 106, by the terminal 106 of User B, are described as Step S607 mentioned above.

Referring to FIG. 7, when User A searches for User B, the calculation unit 110a in User A's terminal 104 creates any combination of personal information of User B and User A, and generates results F(P1a, P1b′), F(P2a, P2a′), F(P1a, P2a, P1a′, P2B′), . . . , F (P1a, P2a, . . . , Pna, P1a′, P2b′, . . . , Pmb′), etc. calculated by using any operation F (Step S701). Any operation F executed by User A's terminal 104 can be calculated in any manner. However, the operation F should be similar to the operation used by User B's terminal 106 while registering (Step S602 and Step S605) the calculation result of personal information of Users A and B that is retained in the database 22. However, the combination of personal information of User A and User B need not be same as the combination of personal information of User A and User B that has been already registered in the server 100 by User B. The transmission and reception unit 110b on UserA's terminal 104 sends the calculation results F(P1a, P1b′), F(P2a, P1a′), F(P1a, P2a, P1a′, P2b), . . . , F(P1a, P2a, . . . , Pna, P1b′, P2b′, Pmb′), etc. of the string combination of any combination of the personal information of User A and User B to the server 100 of the network service provider, and sends a search (25) request to the server 100 (Step S702). These calculation results F(P1a,P1b′), F(P2a,P2b′), F(P1a,P2a,P1b′,P2b), . . . , F(P1a,P2a, . . . , Pna,P1a′,P2b′, . . . , Pmb′), etc. transmitted from User A's terminal 104 are received by the transmission and reception unit 108a of the data processor 108 provided on the server 100 (Step S703). The search unit 108c of the data processor searches for an identical or matching calculation result from the calculation result F(P1a, P1b′), F(P2a, P1b′), F(P1a, P2a, P1b, P2b), . . . , F(P1a, P2a, . . . ,Pna, P1B′, P2b′, . . . , Pmb′), etc., and the calculation results associated with the identification tag IDb of User B or with the connection information (Step S704). In the embodiment 2, the calculation results F(P1a′,P1b), F(P2a, P1b′), F(P1a′,P2a′,P1a,P2b), . . . , F(P1a′, P2a′, . . . , Pna′,P1b,P2b, . . . , Pnb), etc. that are tagged with the identification tag IDb of User B or with the information necessary for a connection are already registered by User B in the database 102 of a network service provider (Step S606). In response to the search request from User A, the search unit 108c on the server 100 of a network service provider searches for the similarity (that is, F(P1a, P1b′)=F(P1a′, P1b), F(P2a, P1b′)=F(P2a′, P1b), F(P1a, P2a, P1b′, P2b)=F(P1a′, P2a′, P1b, P2b), . . . , F(P1a, P2a, . . . , Pna, P1b′, P2b′, . . . , Pmb′)=F(P1a′, P2a′, . . . , Pna′, P1b, P2b, . . . , Pnb) between the calculation results F(P1a, P1b′), F(P2a, P1b′), F(P1a, P2a, P1a′, P2b), . . . , F(P1a, P2a, . . . , Pna, P1b′, P2b′, . . . , Pmb′) etc. that are sent from the terminal 104 to the server 100, and the calculation result F tagged with the identification tag of User B or with the necessary information for a connection that is registered in the database 102. If such similarity is detected, the transmission and reception unit on the server 100 sends identification tags IDb of User B associated with each calculation result, which is similar to the above calculation result to User A's terminal 104 (Step S705). Further, in response to this search request, when the search unit 108c on the server 100 of a network service provider does not detect a single similarity between the calculation results F(P1a, P1b′), F(P2a, P1b′), F(P1a, P2a, P1b′, P2b), . . . , F(P1a, P2a, . . . , Pna, P1b′, P2b′, . . . , Pmb′), etc. that is sent from User A's terminal 104 to the server 100 in order to search for B, and the calculation result F tagged with connection information such as the network ID of B registered in database 102, the server 100 does not send User B's identification tag such as a network service ID present on the network service or the information that is necessary to connect to B, to User A's terminal 104. (Step S706).

As given in the example shown in FIG. 1, also in the embodiment 2, User C, who is a black hat, aims to pretend to be User B when User B's terminal 106 is searched from User A's terminal 104. User C combines any information of User A and User B that is stored on the database 28 of the terminal 105 of User C, for example, F(P1a″,P1b″), F(P1a″,P2b″), F(P2a″,P1b″) calculated using P1a″,P2a″,P1b″,P2b″, with the identification tag IDc of User C and registers it in the database 102 of server 100. Here, when there is no spoofing by User C, the advantages obtained by the method in the present invention and by the conventional methods are compared and described. When there is no spoofing by User C, the following are the two advantages according to the methods related to the embodiment 2 compared to the conventional methods in addition to the five advantages mentioned in the embodiment 1. These advantages are also valid when there is spoofing by User C.

According to the embodiment 2, the sixth advantage is that when two users are to be searched mutually on a network service, even though User B's personal information that is retained on User A's terminal 104 and User A's personal information that is retained on User B's terminal 106 are not the same, User A's terminal 104 can search for User B's terminal 106 and vice versa. For example, in the conventional method, where the name of B, who is being searched, is registered on the server for searching and searcher A searches B's name directly on the server, when A's terminal 104 on the network service searches for B's terminal 106, after retaining User B's name on User A's terminal 104, it is necessary to send a search request for User B's name to the server 100, and vice versa. In other words, when two users try to search each other, after retaining the same attribute personal information of both users ( User B's name on User A's terminal 104, User A's name on User B's terminal 106), it is necessary to enquire each name to the search server. However, according to the method given in the embodiment 2, even in the case where A and B can retain on their terminal only the personal information having different attributes, such as B's telephone number is retained in the database 21 on A's terminal 104 and A's address is stored in the database 22 on User B's terminal 106, if User A's terminal 104 registers B's telephone number and A's address, and User B's terminal 106 registers A's address and B's telephone number respectively in the database 102 on the server 100, User A can search for User B and vice versa.

According to the embodiment 2, the seventh advantage compared with conventional methods as well as the method in the embodiment 1 is that even if the uniqueness of personal information used is low, the possibility that the user, who is being searched, cannot be identified uniquely by the search unit 108c of the server 100 is reduced, in response to the search request from a searcher. For example, according to the method of the embodiment 1, when A having a very common name searches for B having a very common name, there may be multiple of F(Pa′, Pb) in the calculation results that are registered in the database 102 of the search server. For example, when User A tries to search for User B, User B may not be uniquely identified on the search server 100. However, according to the method of the embodiment 2, when User A searches for User B, after registering the calculation results of more than one combination of User B's personal information and User A's personal information (retained in the database 22 on User B's terminal) on the database 102 on the server, since User A sends a query to the server 100 about the calculation result of more than one combination of User A's personal information and User B's personal information that is retained in the database of User A's terminal, the calculation result of combinations of multiple personal information is searched multiple of times, and the possibility of redundancy of a calculation result that is registered in the database 102 on the server reduces further as compared to the method of the embodiment 1. For example, when User A having a common name searches for B having an uncommon name, consider the case where User B's terminal 106 has already registered the calculation results having four combinations in the database 102 on the server. The four combinations are, for example, (1) User A's name+User B's name, (2) User A's company+User B's name, (3) User A's name+User B's company, (4) User A's company+User B's company. Here, when User A's terminal 104 requests the search of a calculation result of two combinations, (1) User A's name and User B's name, (2) User B's name and User A's company to server 100, there is a high possibility of identifying User B uniquely if the condition is to use these two combinations together, even if the information is used wherein it is difficult to identify the search partner uniquely with a common name and a common company individually.

Also in the embodiment 2, as compared to the conventional methods, spoofing is difficult for a black hat since it is necessary to retain the personal information of both the user who is being searched and the searcher. However, even then, spoofing by a black hat cannot be completely prevented. Consequently again referring to FIG. 8, the method to identify the fact and to detect that there is User C, who is a black hat, from User B's terminal 106 is explained when User C, who is a black hat, is searched on User B's terminal 106 by User A's terminal 104, and when User C, who is a black hat, has planned to pretend to be User B.

However, according to the method mentioned in the embodiment two of the present invention, it can be recognized that User C having the identification tag IDc pretends to be the terminal 106 of User B while searching from User A's terminal 104. Referring to FIG. 8, the calculation unit 112a of the terminal 106 of User B generates the calculation results F(P1a′, P1b), F(P2a′, P1b), F(P1a′, P2a′, P1b, P2b), . . . , F(P1a′, P2a′, . . . , Pna′, P1b, P2b, . . . , Pnb) similar to the result that is stored in the database 102 by the server 100, after sending the hash value to the server 100 in step S605 (Step S801). Further, the transmission and reception unit 110b sends the search request (32) by sending all these calculation results to the server (Step S802) in order to detect a black hat. When the transmission and reception unit 108a of the server 100 receives this request and when the search method 108c searches the database 102 (Step S803), if any hash value matches with the result exists (Step S804), then all identification tags attached to each matched hash value from the database 102 of the server 100 are sent to User B's terminal 106 through the transmission and reception unit 108a (Step S805). On the other hand, in User B's terminal 106, the transmission and reception unit 112b receives the identification tag sent by the above-mentioned server (Step S806) and the identification tag comparison unit 112d verifies whether there is an identification tag other than IDb of the terminal 106 of User B (Step S807). If any identification tag other than IDb is detected, there is a high possibility that there is a black hat who is attempting spoofing User B's terminal 106 when User A's terminal 104 is searching for User B's terminal 106.

For example, at Step S802 mentioned above, the identification tags tagged with each calculation result of F(P1a′, P1b), F(P2a′, P1b), F(P1a′, P2a′, P1b, P2b), . . . , and F(P1a′, P2a′, . . . , Pna′, P1b, P2b, . . . Pnb) that are requested for detecting a black hat to the server 100, when all identification tags obtained by User B's terminal 106 at Step S806 are compared with the identification tag IDb of User B herself/himself by the identification tag comparison unit 112d and when the identification tag IDc other than IDb is detected, then there is a high possibility that the identification tag IDc is that of a black hat who intends to pretend to be terminal 106 of User B, when User A's terminal 104 is searching for User B's terminal 106.

In such methods explained above, if a black hat is detected by the recipient of disclosed information, the transmission and reception unit 112b of the terminal 106 of User B, who is the recipient of disclosed information, sends the indication to User A's terminal 104 that spoofing is being executed by the terminal having identification tag IDc (Step S807). A message may be displayed on the display unit of the terminal 104 of User A and User A is alerted. Further, the transmission and reception unit 108a of the terminal 106 of User B sends the command to the server 100 for deleting the calculation result that is registered after tagging with the identification tag IDc of User C, a black hat. In this way, the calculation result which is registered by User C, a black hat, and which is stored with the identification tag IDc, is deleted from the database 102 of the server 100 and spoofing by a black hat can be prevented. All the users of this communication service can use such methods periodically to detect a black hat on the server 100.

According to the methods explained in the embodiment 2, User B, who is being searched, registers a number of calculation results in the database 102 of the server 100, and User A, the searcher, can request for these calculation results to the server 100. Consequently, the following cases, which do not occur in the embodiment 1, may occur in the embodiment 2, when User C, a black hat, is spoofing. For example, the calculation results of a combination of personal information of User A and User B, which is not registered on server 100 by User B's terminal 106 is registered on the server 100 by the terminal 105 of User C, a black hat, with the purpose of spoofing. Further, User A can request for the calculation results of the combination of the personal information to the server 100. In this case, when User A makes a request to search for User B, the calculation result where any matches are found, is the only calculation result that is registered on the server 100 from terminal 105 of User C. Therefore, at Step S705, the identification tag of a search result sent to User A's terminal 104 is the same as that of User C, a black hat. In this way, spoofing can be done successfully. Moreover in this case, the calculation result that is registered on the server 100 by User C, a black hat, is not included in the calculation result requested for the purpose of detecting a black hat, at the above-mentioned step S802 of the embodiment w. Therefore, a black hat registered on the server 100 by the terminal 105 of User C, is not detected successfully by using the methods given in the previous step 804 in the embodiment 2.

In this way, there are some rare cases when User C, a black hat, cannot be detected by using the black hat detection methods given in the embodiment 2. To resolve this problem, when the transmission and reception unit 112b of the terminal 106 of User B sends the hash value to the server 100 at Step S605, first, at Step 801 of the embodiment 2, irrespective of the calculation result, which is the same as the values stored in the database 102 of the server 100, a black hat detection is executed according to the steps shown in FIG. 8 for any or all the combinations of personal information P1b, P2b, . . . , Pmb of User B and personal information P1a′, P2a′, . . . , Pna′ of User A. If the hash value is not stored in the server 100 from User B's terminal 106, it can effectively detect the terminal 105 of User C, a black hat, although a combined calculation result of personal information of User A and User B is registered in the server 100 from the terminal 105 of User C for spoofing.

As mentioned above, while searching the users on a network service by using the methods of an embodiment of the present invention, as compared to conventional methods, spoofing is not easy for a black hat. In addition, spoofing by a black hat can be detected by repeating the provided methods at multiple of times. Therefore, safe search methods can be carried out.

What is claimed is:

1. A system comprising:
an information terminal of a user B which stores information Pa′ of a user A and information Pb of the user B;
an information terminal of a user C which stores information Pa″ of the user A and information Pb″ of the user B; and
a server;
wherein the information terminal of the user B generates a first calculation result F(Pa′, Pb) by an arbitrary calculation of information Pa′ of the user A and information Pb of the user B and sends the first calculation result F(Pa′, Pb) to the server to be registered in the server, the server correlating an identification tag of the user B with the first calculation result F(Pa′, Pb) and storing the identification tag of the user B and the first calculation result F(Pa′, Pb), and the information terminal of the user C generates a second calculation result F(Pa″, Pb″) by the arbitrary calculation of information Pa″ of the user A and information Pb″ of the user B and sends the second calculation result F(Pa″, Pb″) to the server to be registered in the server, the server correlating an identification tag of the user C with the second calculation result F(Pa″, Pb″) and storing the identification tag of the user C and the second calculation result F(Pa″, Pb″), and the server searches for a calculation result which matches the first calculation result F(Pa′, Pb) and sends an identification tag which is correlated with the second calculation result F(Pa″, Pb″), or flag information, the identification tag or the flag information showing that the first calculation result F(Pa′, Pb) and the second calculation result F(Pa″, Pb″) match.

2. A server comprising a data processor, the data processor receiving a first calculation result F(Pa′, Pb) which is calculated by an arbitrary calculation of information Pa′ of a user A and information Pb of a user B, the first calculation result F(Pa′, Pb) being generated in an information terminal of the user B, and correlating an identification tag of the user B with the first calculation result F(Pa′, Pb) and stores the identification tag of the user B and the first calculation result F(Pa′, Pb), and receiving a second calculation result F(Pa″, Pb″) which is calculated by an arbitrary calculation of information Pa″ of the user A and information Pb″ of the user B, the second calculation result F(Pa″, Pb″) being generated in an information terminal of a user C, and correlating an identification tag of the user C with the second calculation result F(Pa″, Pb″) and stores the identification tag of the user C and the second calculation result F(Pa″, Pb″).

3. The server according to claim 2, wherein the data processor receives a third calculation result F(Pa, Pb′) which is calculated by an arbitrary calculation of information Pa of the user A and Pb′ of the user B, the third calculation result F(Pa, Pb′) being generated in an information terminal of the user A, searches for a calculation result which matches the third calculation result F(Pa, Pb′), sends an identification tag which is correlated with the calculation result detected as matching the third calculation result F(Pa, Pb′) in the search, or flag information to an information terminal of the user A, the flag information or the identification tag showing that the second calculation result F(Pa″, Pb″) matches the third calculation result F(Pa, Pb′).

4. The server according to claim 2, wherein the data processor detects a match between the second calculation result F(Pa″, Pb″) and the first calculation result F(Pa′, Pb), based on the first calculation result F(Pa′, Pb) which is received from a terminal of the user B, and in the case where a match is detected, sends a stored identification tag of the user C which is correlated with the second calculation result F(Pa″, Pb″) or flag information to an information terminal of the user B, wherein the identification tag of the user C or the flag information shows that a match between the first calculation result F(Pa′, Pb) and the second calculation result F(Pa″, Pb″) is detected.

5. An information terminal comprising:
a calculation unit which generates a first calculation result F(Pa, Pb′) calculated by an arbitrary calculation of information Pa of a user A and information Pb′ of a user B;
a sending unit which sends the first calculation result F(Pa, Pb′) to a server, and;
a receiving unit,
wherein the server searches for a calculation result which matches the first calculation result F(Pa, Pb′) which is sent from the information terminal, the calculation result being either a second calculation result F(Pa′, Pb) which is calculated by the arbitrary calculation of information Pa′ of the user A and information Pb of the user B, the second calculation result F(Pa′, Pb) being correlated with an identification tag of the user B and stored in the server and sent by an information terminal of the user B, or a third calculation result F(Pa″, Pb″) which is calculated by the arbitrary calculation of information Pa″ of the user A and information Pb″ of the user B, with the third calculation result F(Pa″, Pb″) being correlated with an identification tag of a user C, stored in the server and sent by an information terminal of the user C, and by detecting a match between either of the first calculation result F(Pa, Pb′) and second calculation result F (Pa′, Pb) or the first calculation result F(Pa, Pb′) and the third calculation result F(Pa″, Pb″), the server sends to the terminal either flag information or an identification tag of either the user B or the user C which is correlated with the matching calculation result, wherein the flag information and the identification tag of either the user B or the user C show the match between the first calculation result F(Pa, Pb′) and second calculation result F(Pa′, Pb) or the first calculation result F(Pa, Pb′) and the third calculation result F(Pa″, Pb″).

6. The information terminal according to claim 5, wherein the information terminal has means for searching for an identification tag of the user C from among received identification tags of the user B or the user C.

7. An information terminal comprising:
a calculation unit which generates a first calculation result F(Pa′, Pb) calculated by an arbitrary calculation of information Pb of a user B and Pa′ of a user A;
a sending unit which sends the first calculation result F(Pa′, Pb) to a server, and;
a receiving unit,
wherein the server detects a match between a second calculation result F(Pa″, Pb″) calculated by an arbitrary calculation of information Pa″ of the user A and Pb″ of the user B, the information being stored in an information terminal of a user C and correlated with an identification tag of the user C and sent by an information terminal of the user C, and the first calculation result F(Pa′, Pb) which is received by the server from an information terminal of the user B, and
wherein the receiving unit receives either the identification tag of the user C which is sent to an information terminal of the user B, or flag information, the flag information and the identification tag of the user C showing a match between the first calculation result F(Pa′, Pb) and the second calculation result F(Pa″, Pb″).

8. A system comprising:
an information terminal of a user B that stores a part of or all of information P1a′, P2a′, . . . , Pna′ (where n is an integer) of a user A and a part of or all of information P1b, P2b, . . . , Pmb (where m is an integer) of the user B;
an information terminal of a user C that stores a part of or all of information P1a″, P2a″, . . . , Pna″ of the user A and a part of or all of information P1b″, P2b″, . . . , Pmb″ of the user B; and
a server;
wherein the information terminal of the user B generates one or more first calculation results calculated by an arbitrary calculation of combined the information P1a′, P2a′, . . . , Pna′ of the user A and P1b, P2b, . . . , Pmb of the user B and sends the first calculation results to the server,
wherein the server correlates each of the one or more first calculation results with an identification tag of the user B and stores one or more of the first calculation results and the identification tag of the user B;
wherein the information terminal of the user C generates one or more second calculation results calculated by an arbitrary calculation of combined the information P1a″, P2a″, . . . , Pna″ of the user A and P1b″, P2b″, . . . , Pmb″ of the user B and sends the second calculation results to the server;
wherein the server correlates each of one or more of the second calculation results with an identification tag of the user C and stores one or more of the second calculation results and the identification tag of the user C; and
wherein the server searches for a calculation result among one or more of the second calculation results which matches a calculation result of one or more of the first calculation results and send an identification tag which is correlated with the matching calculation result to the information terminal of the user B.

9. The system according to claim 8, wherein one or more of the first calculation results is one or more among F(P1a′, P1b), F(P1a′, P2′, P1b′, P2b), F(P1a′, P2a′, . . . , Pna′, P1b, P2b, . . . , Pmb) and one or more of the second calculation results is one or more among F(P1a″, P1b″), F(P1a″, P2a″, P1b″, P2b″), . . . , F(P1a″, . . . , P2a″, . . . , Pna″, . . . , P1b″, P2b″, . . . , Pmb″).

10. A server comprising a data processor, the data processor receiving one or more first calculation results calculated by an arbitrary calculation of combined information P1a′, P2a′, . . . , Pna′ (where n is an integer) of a user A and P1b, P2b, Pmb (where m is an integer) of a user B, one or more of the calculation results being generated in an information terminal of the user B, and correlates an identification tag of the user B with one or more of the first calculation results or each of one or more of the first calculation results and stores the identification tag of the user B and one or more of the first calculation results, and receives one or more second calculation results calculated by the arbitrary calculation of combined information P1a″, P2a″, . . . , P1n″ of the user A, and correlates an identification tag of a user C with one or more of the second calculation results or each of one or more of the second calculation results and stores the identification tag of the user C and one or more of the second calculation results.

11. The server according to claim 10, wherein the server receives one or more third calculation results calculated by an arbitrary calculation of combined information P1a, P2a, . . . , Pna of the user A and P1b′, P2b′, . . . , Pmb′ of the user B, one or more of the third calculation results being generated in an information terminal of the user A, searches for a calculation result among one or more of the first calculation results and one or more of the second calculation results which matches a result among one or more of the third calculation results, one or more of the third calculation results being sent from an information terminal of the user A, and sends an identification tag which has been correlated with the detected matching calculation result or flag information to an information terminal of the user A, the flag information and the identification tag showing a match between one or more of the third calculation results and one or more of the second calculation results.

12. The server according to claim 10, wherein the server detects a match between the one more first calculation received from the information terminal of the user B and one or more of the second calculation results, and sends an identification tag of the user C which is correlated with one or more of the second calculation results, or flag information to an information terminal of the user B, the flag information and the identification tag of the user C showing a match is detected between one or more of the first calculation results and one or more of the second calculation results.

13. An information terminal comprising:
a calculation unit which generates a first calculation result group calculated by an arbitrary calculation of a part of or all of information P1a, P2a, . . . , Pna of a user A and a part of or all of information P1b′, P2b′, . . . , Pmb′ of a user B;
a sending unit which sends the first calculation result group to a server, and;
a receiving unit, wherein the server searches for a calculation result which matches the first calculation result group which is sent from the information terminal of the user A, the calculation result group being either a second calculation result group which is calculated by the arbitrary calculation of arbitrary combination of a part of or all of information P1a′, P2a′, . . . , Pna′ of the user A and information P1b, P2b, Pmb of the user B, the second calculation result group being correlated with an identification tag of the user B and stored in the server and sent by an information terminal of the user B, or a third calculation result group which is calculated by the arbitrary calculation of arbitrary combination of a part of or all of information P1a″, P2a″, . . . , Pna″ of the user A and information P1b″, P2b″, . . . , Pmb″ of the user B, the third calculation result group being correlated with an identification tag of a user C and stored in the server and sent by an information terminal of the user C, and by detecting a match between the first calculation result group and the second calculation result group or the first calculation result group and the third calculation result group receives an identification tag of the user B or the user C which is correlated with the matching calculation result, the identification tag of the user B or the user C being sent to the information terminal of the user A, or flag information, the flag information and the identification tag of the user B or the user C showing a match between the first calculation result group and the second calculation result group or the first calculation result group and the third calculation result group.

14. The information terminal according to claim 13, wherein the information terminal has a means for searching for an identification tag of the user C from among received identification tags of the user B or the user C.

15. An information terminal comprising:
a calculation unit which generates a first calculation result group calculated by an arbitrary calculation of arbitrary combination of a part of or all of information P1b, P2b, . . . , Pmb of a user B and information P1a′, P2a′ . . . , Pna′ of a user A;
a sending unit which sends the first calculation result group to a server, and;
a receiving unit,
wherein the server detects a match between a second calculation result group calculated by an arbitrary calculation of arbitrary combination of a part of or all of information P1a″, P2a″, . . . , P2a″ of the user A and P1b″, P2b″, . . . , Pmb″ of the user B, the information being stored in an information terminal of a user C and correlated with an identification tag of the user C and sent by the information terminal of the user C, and the first calculation result group which is received by the server from an information terminal of the user B, and the receiving unit receives either the identification tag of the user C which is sent to the information terminal of the user B, or flag information, the flag information and the identification tag of the user C showing a match between the first calculation result group and the second calculation result group.

16. A method of operating a system for detecting a black hat, the system comprising an information terminal of a user B which stores information Pa′ of a user A and information Pb of the user B; an information terminal of a user C which stores information Pa″ of the user A and information Pb″ of the user B; and a server; wherein the information terminal of the user B generates a first calculation result F(Pa′, Pb) by an arbitrary calculation of information Pa′ of the user A and information Pb of the user B and sends the first calculation result F(Pa′, Pb) to the server to be registered in the server, the server correlating an identification tag of the user B with the first calculation result F(Pa′, Pb) and storing the identification tag of the user B and the first calculation result F(Pa′, Pb), and the information terminal of the user C generates a second calculation result F(Pa″, Pb″) by the arbitrary calculation of information Pa″ of the user A and information Pb″ of the user B and sends the second calculation result F(Pa″, Pb″) to the server to be registered in the server, the server correlating an identification tag of the user C with the second calculation result F(Pa″, Pb″) and storing the identification tag of the user C and the second calculation result F(Pa″, Pb″), and the server searches for a calculation result which matches the first calculation result F(Pa′, Pb) and sends an identification tag which is correlated with the second calculation result F(Pa″, Pb″), or flag information, the identification tag or the flag information showing that the first calculation result F(Pa′, Pb) and the second calculation result F(Pa″, Pb″) match.

17. A method of operating a server for detecting a black hat, the method comprising:
receiving a first calculation result F(Pa′, Pb) which is calculated by an arbitrary calculation of information Pa′ of a user A and information Pb of a user B, the first calculation result F(Pa′, Pb) being generated in an information terminal of the user B;
correlating an identification tag of the user B with the first calculation result F(Pa′, Pb) and stores the identification tag of the user B and the first calculation result F(Pa′, Pb);
receiving a second calculation result F(Pa″, Pb″) which is calculated by an arbitrary calculation of information Pa″ of the user A and information Pb″ of the user B, the second calculation result F(Pa″, Pb″) being generated in an information terminal of a user C; and
correlating an identification tag of the user C with the second calculation result F(Pa″, Pb″) and stores the identification tag of the user C and the second calculation result F(Pa″, Pb″).

18. A method of operating an information terminal for detecting a black hat, the method comprising:
generating a first calculation result F(Pa, Pb′) calculated by an arbitrary calculation of information Pa of a user A and information Pb′ of a user B; and
transmitting the first calculation result F(Pa, Pb′) to a server;
wherein the server searches for a calculation result which matches the first calculation result F(Pa, Pb′) which is sent from an information terminal of the user A, the calculation result being either a second calculation result F(Pa′, Pb) which is calculated by the arbitrary calculation of information Pa′ of the user A and information Pb of the user B, second calculation result F(Pa′, Pb) being correlated with an identification tag of the user B and stored in the server and sent by an information terminal of the user B, or a third calculation result F(Pa″, Pb″) which is calculated by the arbitrary calculation of information Pa″ of the user A and information Pb″ of the user B, third calculation result F(Pa″, Pb″) being correlated with an identification tag of a user C and stored in the server and sent by an information terminal of the user C, and by detecting a match between the first calculation result F(Pa, Pb′) and second calculation result F (Pa′, Pb) or the first calculation result F(Pa, Pb′) and the third calculation result F(Pa″, Pb″) receives an identification tag of the user B or the user C which is correlated with the matching calculation result, the identification tag of the user B or the user C being sent to an information terminal of the user A, or flag information, the flag information and the identification tag of the user B or the user C showing a match between the first calculation result F(Pa, Pb′) and second calculation result F(Pa′, Pb) or the first calculation result F(Pa, Pb′) and the third calculation result F(Pa″, Pb″).

19. A method of operating an information terminal for detecting a black hat, the method comprising:
generating a first calculation result F(Pa′, Pb) calculated by an arbitrary calculation of information Pb of a user B and Pa′ of a user A; and
transmitting the first calculation result F(Pa′, Pb) to a server,
wherein the server detects a match between a second calculation result F(Pa″, Pb″) calculated by an arbitrary calculation of information Pa″ of the user A and Pb″ of the user B, the information being stored in an information terminal of a user C and correlated with an identification tag of the user C and sent by an information terminal of the user C, and the first calculation result F(Pa′, Pb) which is received by the server from an information terminal of the user B, and the receiving unit receives either the identification tag of the user C which is sent to an information terminal of the user B, or flag information, the flag information and the identification tag of the user C showing a match between the first calculation result F(Pa′, Pb) and the second calculation result F(Pa″, Pb″).

20. A method of operating a server for detecting a black hat, the server comprising: an information terminal of a user B that stores a part of or all of information P1a′, P2a′, . . . , Pna′ (where n is an integer) of a user A and a part of or all of information P1b, P2b, . . . , Pmb (where m is an integer) of the user B; an information terminal of a user C that stores a part of or all of information P1a″, P2a″, . . . , Pna″ of the user A and a part of or all of information P1b″, P2b″, . . . , Pmb″ of the user B;
wherein the information terminal of the user B generates one or more first calculation results calculated by an arbitrary calculation of combined the information P1a′, P2a′, . . . , Pna′ of the user A and P1b, P2b, . . . , Pmb of the user B and sends the first calculation results to the server, wherein the server correlates each of one or more of the first calculation results with an identification tag of the user B and stores one or more of the first calculation results and the identification tag of the user B; wherein the information terminal of the user C generates one or more second calculation results calculated by an arbitrary calculation of combined the information P1a″, P2a″, . . . , Pna″ of the user A and P1b″, P2b″, . . . , Pmb″ of the user B and sends the second calculation results to the server; wherein the server correlates each of one or more of the second calculation results with an identification tag of the user C and stores one or more of the second calculation results and the identification tag of the user C; and wherein the server searches for a calculation result among one or more of the second calculation results which matches a calculation result of one or more of the first calculation results and send an identification tag which is correlated with the matching calculation result to the information terminal of the user B.
